(19) United States
(12) Patent Application Publication
(10) Pub. No.: US 2010/0060741 A1
(43) Pub. Date: Mar. 11, 2010

(54) PASSIVE AND REMOTE MONITORING OF CONTENT DISPLAYED BY A CONTENT VIEWING DEVICE

(75) Inventors: Rika Allard, San Diego, CA (US); Peter Shintani, San Diego, CA (US)

Correspondence Address: LEVEQUE INTELLECTUAL PROPERTY LAW, P.C., 241 E. 4th Street, #102, FREDERICK, MD, 20701, US

(73) Assignees: SONY CORPORATION, Tokyo (JP); SONY ELECTRONICS, INC., Park Ridge, NJ (US)

(21) Appl. No.: 12/206,047

(22) Filed: Sep. 8, 2008

(51) Int. Cl. H04N 17/00

(52) U.S. Cl. 348/180; 348/E17.001

(57) ABSTRACT

A method and system provide for passive monitoring by a monitor entity of content displayed for viewing by a content viewing device. Generally, one or more content source parameters of a content viewing device are observed or monitored. From the one or more content source parameters are determined content displayed for viewing on the content viewing device. One or more content data representative of the displayed content is next extracted. A monitor entity passively monitors the one or more content data and optionally the one or more content source parameters of the content viewing device. The monitor entity may be a person, an external device programmed to do monitoring, or a person interfacing with an external device.

### COPYRIGHT NOTICE

A portion of the disclosure of this patent document may contain material that is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

There are circumstances in which a third party, be it a parent, a guardian or employer, is interested in knowing the viewing patterns of a viewer viewing content displayed by a content viewing device, such as a television. Such a third party may be concerned about the amount of programming and the type of content that is being viewed. A parent, for instance, may wish to protect a child from content of dubious value as well as to protect the child from too much television or video gaming. An employer may be concerned about the amount of time an employee spends playing video games or Internet programming, as opposed to performing actual work.

Current solutions are proactive in blocking viewing based upon criteria such as the amount of time spent viewing or the type (rating) of the programming being watched. Televisions sold in the United States, for example, have V block capability that allows a parent or guardian to set up the V block function to block programming considered undesirable; control of the blocking function is controlled by a password. The channel blocking function may be easily defeated by the child guessing the password. Channel blocking does not address the issue of the amount of programming that is being viewed. Moreover, it does not provide a way to simply monitor viewing patterns since the blocking function is, by definition, an intrusive one.

### BRIEF DESCRIPTION OF THE DRAWINGS

The features of the invention believed to be novel are set forth with particularity in the appended claims. The invention itself however, both as to organization and method of operation, together with objects and advantages thereof, may be best understood by reference to the following detailed description of the invention, which describes certain exemplary embodiments of the invention, taken in conjunction with the accompanying drawings in which:

FIG. 1 is a functional block diagram of a content viewing system that provides for passive monitoring of content displayed for viewing, in accordance with various embodiments.

FIGS. 2-4 are flowcharts that illustrate methodologies for passively monitoring content displayed for viewing, in accordance with various embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION

While this invention is susceptible of embodiment in many different forms, there is shown in the drawings and will herein be described in detail specific embodiments, with the understanding that the present disclosure is to be considered as an example of the principles of the invention and not intended to limit the invention to the specific embodiments shown and described. In the description below, like reference numerals are used to describe the same, similar or corresponding parts in the several views of the drawings.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

In accordance with various embodiments of the present invention, a method and system provide for the passive monitoring by a monitor entity of content displayed for viewing by a content viewing device. Generally, one or more content source parameters of a content viewing device are observed or monitored. From the one or more content source parameters are determined content displayed for viewing on the content viewing device. One or more content data representative of the displayed content is next extracted. A monitor entity passively monitors the one or more content data and optionally the one or more content source parameters of the content viewing device. The monitor entity may be a person, an external device programmed to do monitoring, or a person interfacing with an external device. In the case of an external device, the extracted one or more content data are transmitted to the external device for remote and passive monitoring. The content data may have been previously stored in a storage element of the content viewing device or it may be transmitted or downloaded in real time to the external device to be available for immediate monitoring. Moreover, the content data may optionally be stored in a storage element of the external device to allow for the monitor entity to passively monitor the content that was viewed on the content viewing device at some later time. The monitor entity may monitor the content viewed by means of an interface element of the content viewing device or of the external device. Optionally, the monitor entity may monitor not only the one or more content data, but also the content source parameters of the content viewing device.

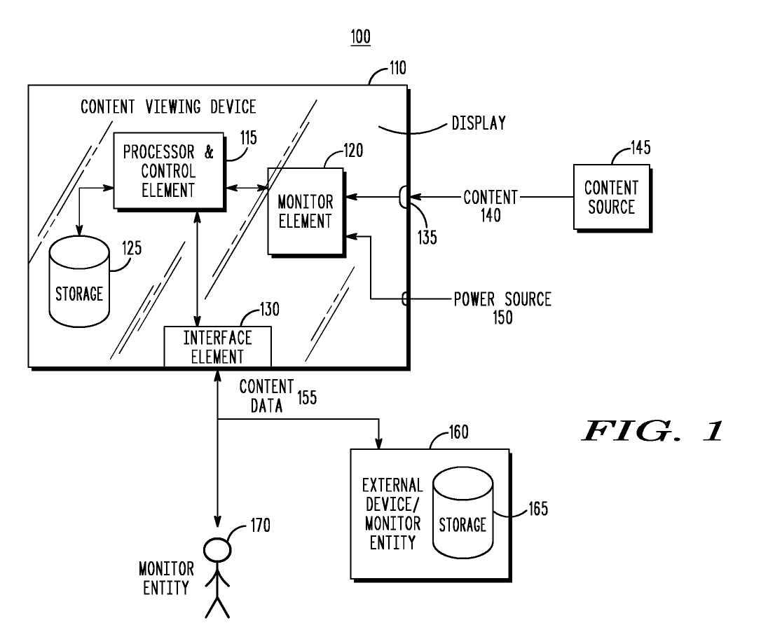

Referring now to the drawings, FIG. 1 illustrates a system block diagram 100, in accordance with various embodiments of the invention. A content viewing device provides content for viewing by a viewer, such as a child or person. The content viewing device may be considered to be any device capable of delivering content for viewing by a user. Examples of a content viewing device include a television, a digital television, a flat screen television, any of which may be cable or satellite and/or connected to a video player (DVD or VCR) to provide content from a DVD movie, video game, etc.; a video cassette recorder/player; a video disk player; an audio player such as a DVD player or radio; a personal digital assistant (PDA); a cellular or mobile phone; or a portable media player. These types of content viewing devices are able to offer a viewer a great variety and amount of content, including television, cable or satellite television programming; video and interactive games, programming for a personal digital assistant (PDA); and other applications or programming.

Such content 140 is provided to the content viewing device 110 at content input terminal 135 from a variety of content sources 145 for display on the screen of the content viewing device. Power 150 is provided to content viewing device 110.

It is desired that a person other than the viewer be able to passively monitor the viewing habits of the viewer without the knowledge of the viewer. In this sense, then, the embodiments described herein differ from various blocking technologies such as V block in that the passive and remote monitoring capabilities provided herein to do interference with or abridge the viewing ability of the viewer. It is noted that as used herein, “viewing” refers to receipt of the content whether it be audio (such as music or radio), visual (images only), text or audio/visual.

System 100 of FIG. 1 shows that content viewing device 110 has several elements to assist in this goal: processor and control element 115, monitor/observation element 120; storage element 125 and interface element 130. In accordance with various embodiments, one or more content source parameters of the content viewing device may be monitored or observed. This is accomplished by monitor element 120. Content source parameters of the content viewing device may include a tuned content source like a satellite feed coming into a satellite television and providing satellite programming; a video content source like a video signal feed coming to a television from a DVD or VCR player; and whether the content viewing device is powered. Observation of one or more content source parameters allow the content being displayed for viewing to be determined; the content may be from a video game, a satellite or cable television program, etc.

The observation element 120 also is able to extract from the incoming content one or more content data that is representative of the content being displayed for view by the content viewing device. The one or more content data representative of the content displayed may be the actual content being displayed by the content viewing device, a number of sampled static images of the content displayed, scaled down images of the content displayed, sampled audio only (no video) of the content displayed, and program information, such as the title, rating, duration, etc. of the content being viewed. Such program information may be readily ascertained from a satellite or cable television program signal coming into the content viewing device; it may also be determined from header information from a music CD or movie DVD, as examples.

Exemplary embodiments regarding extracting one or more content data from content being display include the following. Program information may be extracted from an extended data service (XDS) stream of an analog channel of the content viewing device. Or, program information may be extracted from a program and system information protocol (PSIP) data of a digital broadcast displayed by the content viewing device. Program information may also be extracted from digital cable or digital satellite programming displayed by the content viewing device, including out-of-band data for cable. Moreover, program information may be extracted from an Electronic Program Guide (EPG), including Interactive Program Guide (IPG) or Electronic Service Guide (ESG), data streams associated with scheduled broadcast television or radio programs and displayed for viewing by a viewer on the content viewing device.

The content data is provided to the processor and control element 115 from observation element 120 as shown. It may be stored for later retrieval in storage element 125. It may also in addition to, or instead of, be transmitted to a monitor entity, such as a person 170 or an external device 160, for passive monitoring of the viewed content via review of the transmitted content data. If content data 155 is transmitted to external device 160 for remote passive monitoring, it may also be stored upon receipt in storage element 165 for later retrieval at external device 160 if desired. Monitoring person 170 may access the content data 155 at the user interface 130 of the content viewing device or at a user interface of the external device.

In the case where passive monitoring of the content being viewed is to be performed remotely, the one or more content data may be transmitted by the interface element 130 to external device 160.

Examples of suitable external devices may include a television, a digital television, a flat-screen television, a remote control device, a set-top box, a personal digital assistant (PDA), a personal computer (PC), a computer monitor, a personal computer, a radio frequency identification (RFID) tag incorporated into an external device, a remote control. The external device with incorporated RFID tag and the remote control device are examples of portable remote user interfaces by which a person as monitor entity may remotely and passively monitor the viewing patterns of a person viewing content on the content viewing device. The external device could be identified by the content viewing device 110 as an authorized monitor. This would allow content viewing device 110 to authenticate the external device and/or authorized person, who is in possession of the RFID tag embedded device, for example, to automatically be authorized to review the content.

The content data may be reviewed by a monitor entity, such as person 170, remotely by external device 160 in the case where the content data has been transmitted to it, or by a person accessing the content data at external device 160 via user interface 130. The passive monitoring may occur in real time proximate to the time that the content is actually being displayed for viewing or at some later time, in which case the one or more content data would be stored in storage element 125 or storage element 165 as appropriate.

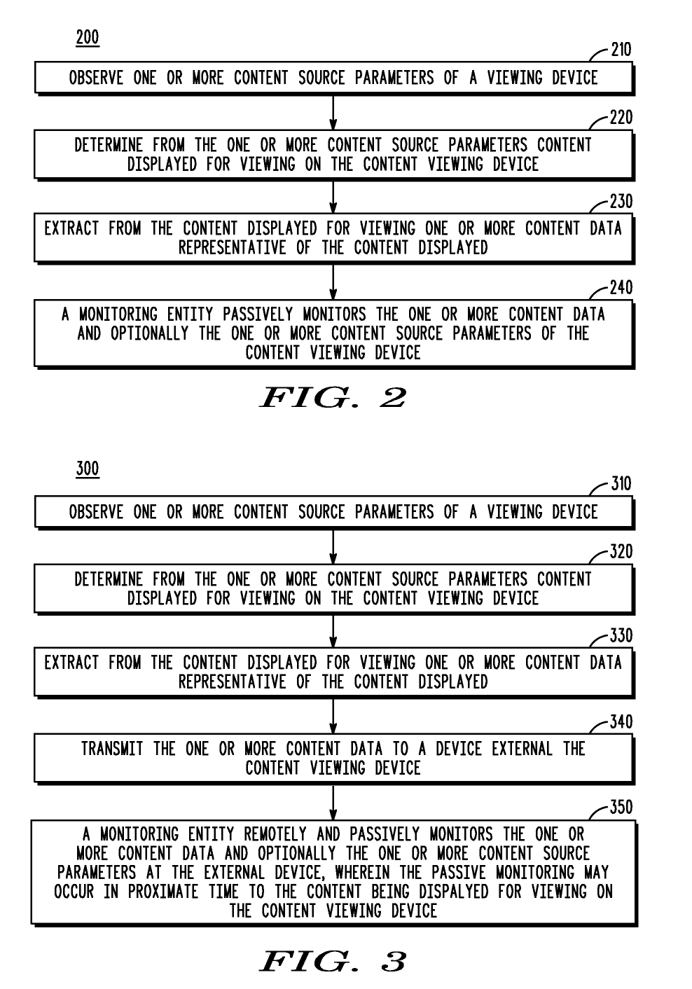

Referring now to the flows of FIGS. 2-4, methodologies in accordance with various embodiments will be described. In flow 200 of FIG. 2, one or more content source parameters of a content viewing device are observed at Block 210. At Block 220, the content being displayed for viewing on the content viewing device is determined from the one or more content source parameters. At Block 230, one or more content data are extracted from the content; the content data is representative of the content presented for viewing. As previously described, extraction of the one or more content data may include extracting the actual content being displayed by the content viewing device, extracting sampled static images of the content displayed, extracting scaled down images of the content displayed so as to conserve bandwidth and processing required, extracting sampled audio of the content displayed, and extracting program information. As detailed above, program information may be extracted from an extended data service (XDS) stream of an analog channel of the content viewing device. Or, program information may be extracted from a program and system information protocol (PSIP) data of a digital broadcast displayed by the content viewing device. At Block 240, a monitoring entity passively monitors the one or more content data and optionally the one or more content source parameters of the content viewing device. It is noted that in addition to the process flow shown here, optional time stamping of the one content source parameters of the content viewing device and the one or more content data may be performed.

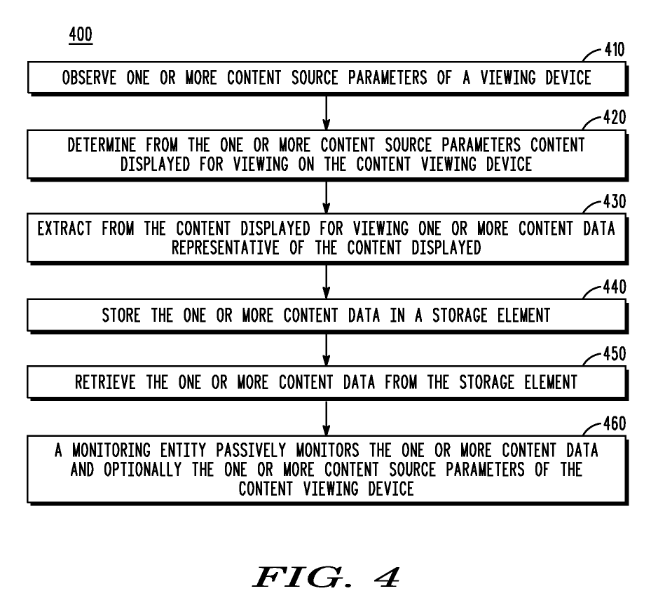

Referring now to FIG. 3, flowchart 300 illustrates transmittal of content data to an external device, in accordance with various embodiments. At Block 310, one or more content source parameters of a content viewing device are monitored/observed. At Block 320, content being provided for viewing is determined from the one or more content source parameters content displayed for viewing on the content viewing device. Next, at Block 330, one or more content data representative of the content displayed are extracted from the content displayed for viewing. The one or more content data are transmitted to a device external the content viewing device at Block 340. At Block 350, a monitoring entity remotely and passively monitors the one or more content data and optionally the one or more content source parameters at the external device, wherein the passive monitoring may occur in proximate time to the content being displayed for viewing on the content viewing device. As previously discussed, the monitoring entity may be a person or an application of the external device operating under control of programmed instructions.

In the case of a device operating in accordance with programmed instructions to monitor the content data, the device may generate a report from the content data in accordance with reporting instructions that form part of the programmed instructions. This is especially good for a parent or an employer, for example, who wishes to look at statistical or grouped data concerning viewing habits. Thus, the external device may have programming capable of generating an alert indicator in response to the one or more content data violating an alert condition of the programmed instructions. Consider for example, the case of a parent who wishes to be alerted when her child views inappropriate programming or spends too much time engaged in video gaming. The alert condition would be the type of programming (i.e. video games or pornography) that would trigger the generation of an alert indicator, such as an electronic mail or call to the parent's work or cell phone number. Again, it is noted that the passive monitoring described herein alerts the monitoring entity of viewing patterns/usage but need not disable viewing itself Of course, the person doing the monitoring may have the option or ability to disable the viewing of programming if so desired.

It is noted that the one or more content data may be transmitted to the external device on a network comprising the external device and the content viewing device. The one or more content data may be also transmitted to the external device via the Internet. The one or more content data may be streamed to the external device. For example, if the content data is program information of the content displayed, the program information may be streamed as an RSS ticker in the RSS web feed format to the monitoring entity.

Referring now to FIG. 4, flowchart 400 illustrates passive monitoring including storage of content data. At Block 410, one or more content source parameters of a content viewing device are observed. Next, at Block 420, content displayed for viewing is determined from the one or more content source parameters. At Block 430, one or more one or more content data representative of the content displayed are extracted from the content. At Block 440, the one or more extracted content data are stored in a storage element. As discussed previously, the content data may be stored in a storage element coupled to the content viewing device or in a storage element coupled to an external device. The storage element may reside within a network, such as the Internet, to which the content viewing device and/or the external device belongs. This allows the stored content data to be retrieved as need from the storage element at Block 450. At Block 460, a monitoring entity passively monitors the one or more content data and optionally the one or more content source parameters of the content viewing device.

It will be appreciated that embodiments of the invention described herein may be comprised of one or more conventional processors and unique stored program instructions that control the one or more processors to implement, in conjunction with certain non-processor circuits, some, most, or all of the functions described herein. The non-processor circuits may include, but are not limited to, a receiver, a transceiver, a radio, signal drivers, clock circuits, power source circuits, and user input devices. As such, these functions may be interpreted as a method to perform functions in accordance with certain embodiments consistent with the present invention. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Those skilled in the art will recognize that exemplary embodiments of the present invention may be based upon use of a programmed processor. However, the invention should not be so limited, since the present invention could be implemented using hardware component equivalents such as special purpose hardware and/or dedicated processors which are equivalents to the invention as described and claimed. Similarly, general purpose computers, microprocessor based computers, micro-controllers, optical computers, analog computers, dedicated processors and/or dedicated hard wired logic may be used to construct alternative equivalent embodiments of the present invention.

Those skilled in the art will appreciate that the program steps and associated data used to implement the embodiments described above can be implemented using various forms of storage, such as, for example, Read Only Memory (ROM) devices, Random Access Memory (RAM) devices, disk storage, optical storage elements, magnetic storage elements, magneto-optical storage elements, flash memory, and/or other equivalent storage technologies without departing from the present invention. Such alternative storage devices should be considered equivalents.

Various embodiments described herein are implemented using programmed processors executing programming instructions that are broadly described above in flow chart form that can be stored on any suitable electronic storage medium or transmitted over any suitable electronic communication medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

What is claimed is:

1. A method for passively monitoring content displayed for viewing on a content viewing device, comprising:
observing one or more content source parameters of a content viewing device;
determining content displayed for viewing on the content viewing device from the one or more content source parameters;
extracting one or more content data representative of the content displayed for viewing from the content displayed; and
a monitor entity passively monitoring the one or more content data, wherein passively monitoring the one or more content data does not affect viewing of the content displayed for viewing by the content viewing device.

2. The method of claim 1, wherein the one or more content source parameters comprise one or more of a tuned content source and a video content source.

3. The method of claim 1, wherein the one or more content data representative of the content displayed comprises one or more of the content displayed by the content viewing device, a plurality of sampled static images of the content displayed, a plurality of scaled down images of the content displayed, a plurality of sampled audio of the content displayed, and program information.

4. The method of claim 3, further comprising extracting the program information from one or more of an XDS stream of an analog channel of the content viewing device, a PSIP data of a digital broadcast displayed by the content viewing device, digital cable data displayed by the content viewing device, digital satellite data displayed by the content viewing device, and an electronic program guide data stream displayed by the content viewing device.

5. The method of claim 1, further comprising the monitor entity passively monitoring the one or more content source parameters of the content viewing device.

6. The method of claim 1, further comprising time stamping one or more of the one or more content source parameters of the content viewing device and the one or more content data.

7. The method of claim 1, further comprises transmitting the one or more content data to a device external the content viewing device; and
the monitor entity remotely monitoring the one or more content data at the external device.

8. The method of claim 7, further comprising transmitting the one or more content data to the external device on a network comprising the external device and the content viewing device.

9. The method of claim 7, further comprising streaming the one or more content data about the displayed content to the device external the content viewing device.

10. The method of claim 7, wherein the monitor entity comprises a device operating in accordance with programmed instructions to monitor the one or more content data and the device generating a report from the received one or more content data in accordance with reporting instructions of the programmed instructions.

11. The method of claim 10, wherein the monitor entity comprises a device operating in accordance with programmed instructions to monitor the one or more content data and the device generating an alert indicator in response to the one or more content data violating an alert condition.

12. The method of claim 1, wherein the monitor entity passively monitoring the one or more content data occurs as the content is displayed for viewing on the content viewing device.

13. The method of claim 1, further comprising:
storing the one or more content data in a storage element;
retrieving the one or more content data from the storage element; and
transmitting the retrieved one or more content data to the monitor entity in response to a request from the monitor entity.

14. The method of claim 13, wherein the storage element is coupled to the content viewing device and the one or content data is transmitted to the monitor entity via a network communication link between the content viewing device and the monitor entity.

15. The method of claim 13, wherein the storage element is coupled to the monitor entity and wherein storing the one or more content data comprises transmitting the one or more content data to the monitoring element to be stored in the storage element.

16. The method of claim 13, wherein the monitor entity comprises a device operating in accordance with programmed instructions to monitor the one or more content data and further comprising the device generating a report from the received one or more content data in accordance with reporting instructions of the programmed instructions.

17. The method of claim 13, wherein the monitor entity comprises a device operating in accordance with programmed instructions to monitor the one or more content data and further comprising the device generating an alert indicator in response to the one or more content data violating an alert condition of the programmed instructions

18. A system suitable for the passive monitoring of content displayed for viewing, comprising:
a content viewing device comprising:
a display element that displays content for viewing;
a processor and control element;
an observation element that observes one or more content source parameters;
a storage element
an interface element;
wherein the processor and control element determines from the one or more content source parameters content displayed by the display element and extracts from the content displayed for viewing one or more content data representative of the content displayed for viewing; and
a monitor entity coupled to the content viewing device, wherein the monitor entity receives the one or more content data representative of the content from the interface element of the content viewing device and passively monitors the one or more content data to determine a viewing pattern of the content displayed for viewing.

19. The system of claim 18, wherein the monitor entity is one of a person who interacts directly with the interface element of the content display device and a device external to the content viewing device.

20. The system of claim 18, wherein the monitor entity is a person who receives the one or more content data at a device external the content viewing device.

21. The system of claim 20, wherein the external device receives the one or more content data from the interface element of the content viewing device.

22. The system of claim 18, wherein the monitor entity comprises a device operating in accordance with programmed instructions to monitor the one or more content data.

23. The system of claim 22, further comprising the device generates a report from the received one or more content data in accordance with reporting instructions of the programmed instructions.

24. The system of claim 22, further comprising the device generates an alert indicator in response to the one or more content data violating an alert condition of the programmed instructions.

25. The system of claim 18, wherein the content viewing device comprises one or more of a television, a video cassette recorders, a video disk player, an audio player, a personal digital assistant (PDA), a cellular or mobile phone, a portable media player

26. The system of claim 18, wherein the device external the content viewing device comprises one or more of a television, a digital television, a flat-screen television, a remote control device, a set-top box, a personal digital assistant (PDA), a computer monitor, a personal computer, an external device having a RFID tag, and a remote control device.
